(19) United States
(12) Patent Application Publication
(10) Pub. No.: US 2024/0400356 A1
(43) Pub. Date: Dec. 5, 2024

(54) SHEAVE ASSEMBLY

(71) Applicant: Mindling Design Limited, Doncaster (GB)

(72) Inventor: Andre Minnis, Doncaster (GB)

(73) Assignee: Mindling Design Limited, Doncaster (GB)

(21) Appl. No.: 18/698,655

(22) PCT Filed: Aug. 11, 2022
(86) PCT No.: PCT/GB2022/052091

§ 371 Date: Apr. 4, 2024

(30) Foreign Application Priority Data
Oct. 6, 2021 (GB) 2114316.9

(51) Int. Cl. B66D 3/04; E21B 19/02

(52) U.S. Cl. CPC B66D 3/04; E21B 19/02

(57) ABSTRACT

The present application provides a sheave assembly (20) comprising a housing (21) with an attachment feature (22) for attaching the sheave assembly to an external mounting point. The sheave assembly also has a sheave wheel (23) mounted to the housing for rotation relative to the housing. The housing comprises a pair of flanges (25a, 25b) extending radially past a periphery of the sheave wheel (23) so as to define a guide channel (26) aligned with the sheave wheel. The pair of flanges (25a, 25b) extend substantially entirely about the circumference of the sheave wheel.

This invention relates to a sheave assembly, for example a sheave assembly for use in a wireline rig up, a slickline rig up, lifting or hoisting apparatus, and/or sailing.

### BACKGROUND

Wirelines and slicklines are used in hydrocarbon wells for workover, production maintenance and logging. A wireline is an electrical cable used to lower tools into the well and to transmit data to and from the surface, for example data from the well bore to surface about the conditions in the well or a signal from surface to down hole tools to activate or function. A slickline is a typically non-electrical wire used to lower tools into the well. A slickline is typically a single strand wire used for mechanical operations, with some slicklines being surface coated to allow electrical transmissions, whereas wirelines are typically braided wires.

Slicklines and wirelines are typically provided within a wireline rig up or slickline rig up, such as that illustrated in FIG. 1A. As shown, the wireline/slickline rig up 1 includes a drum 2 of the wireline/slickline wire 3 and one or more pulleys 4, 5 arranged to route the wireline or slickline 3 into a wireline valve/manifold 6 mounted to the well 7. The wireline/slickline rig 1 includes a lubricator 8 that is mounted to the wireline valve/manifold 6 (e.g., Christmas tree) of the well 7. The wireline/slickline 3 passes through the lubricator 8 and then into the well 7 via the wireline valve/manifold 6. The wireline/slickline 3 can be lowered and raised by turning the drum 2 hydraulically, mechanically or electrically.

As shown, the wireline/slickline rig up 1 may also include a load and depth measuring unit 9 to detect the load on the wireline/slickline 3 and the depth of wire 3 run into the well 7. The load measuring unit 9 has one or more pulleys, in this example two pulleys 10a, 10b, which can be mounted vertically one on top of the other, as illustrated, or alternatively horizontally side by side. The wireline/slickline 3 is wrapped around the pulleys 10a, 10b so that they are urged towards each other by the tension in the wireline/slickline 3. A load cell 11 is provided between the two pulleys 10a, 10b to measure the force for determining the tension in the wireline/slickline 3. A tool depth system is fitted to the pulley 10a to indicate the length of wire run into the well 7.

As illustrated in FIG. 1A, the wireline/slickline rig 1 typically includes a lower hay pulley 4 and an upper hay pulley 5. The lower hay pulley 4 is tethered to the well head 7 or deck (or optionally the lubricator 8) and used to route the wireline/slickline 3 from the drum 2 towards the top of the lubricator 8. A stuffing box 12 is provided at the top of the lubricator 8 to provide access for the wireline/slickline 3. The stuffing box 12 typically has a seal to provide some form of pressure control and contains the well pressure. The upper hay pulley 5 is mounted to the stuffing box 12 and routes the wireline/slickline 3 from the lower hay pulley 4 into the stuffing box 12 and lubricator 8. The tension in the wireline/slickline 3 holds the lower hay pulley 4 in position with the tether pulled taught. A load cell may be between the taught sling 4a and the bottom pulley 4, particularly if no measuring unit 9 is provided.

As shown in FIG. 1B, each of the upper and lower hay pulleys 4, 5 typically comprises a frame 13 to which a pulley disc 14 is mounted via a shaft 15. The frame 13 has two spaced apart arms and the pulley disc 14 is located between the arms with the shaft 15 passing therethrough so that the pulley disc is rotatably mounted to the frame 13. A radial guard or multiple rollers or guides 16 may be mounted to the frame 13 adjacent to the outer circumference of the pulley disc 14 to hold the wireline/slickline on the pulley disc 14 at that location. The frame 13 also includes an attachment feature 17, typically a clevis or eye, for attaching the hay pulley 4, 5 to the rig up.

There is a general need to reduce the weight of the hay pulleys so as to reduce the loads that have to be assembled onto the wireline valve/manifold and allow safer manual handling of the hay pulley when rigging up. In addition, it is desirable to reduce the weight of the lower hay pulley so as not to unduly increase the load on the wireline/slickline.

To reduce the weight of the hay pulleys it is known to make the pulley wheel from an alloy, polymer or composite material, or to provide cutaway openings in the pulley disc. However, such pulley discs experience increased distortion during use, which can cause the wireline/slickline to be pinched between the pulley disc and the guard, rollers or guides and jump off the pulley disc. This requires work to stop while the wireline/slickline is repositioned and can potentially damage the hay pulley or break the wireline/slickline. Any breaking of the wire puts the well at risk and can cause the leak of hydrocarbons.

Similar hay pulleys are used in other applications, particularly industrial lifting and hoisting such as in the construction and manufacturing industries, and also in sailing and maritime industries.

### BRIEF SUMMARY OF THE DISCLOSURE

In accordance with the present disclosure there is provided a sheave assembly comprising:
a housing with an attachment feature for attaching the sheave assembly to an external mounting point, and
a sheave wheel mounted to the housing for rotation relative to the housing;
wherein the housing comprises a pair of flanges extending radially past a periphery of the sheave wheel so as to define a guide channel aligned with the sheave wheel, and wherein the pair of flanges extend substantially entirely about the circumference of the sheave wheel.

Accordingly, the guide channel is formed between the flanges of the housing and acts to retain alignment between a line and the sheave wheel during use. In addition, as the flanges (and guide channel) extend substantially entirely about the circumference of the sheave wheel, the line can be securely held in alignment with the sheave wheel regardless of the degree of wrap of the line about the sheave wheel, and regardless of the angle of the line as it approaches/travels away from the sheave wheel.

In examples, the guide channel comprises a width between the pair of flanges, and a depth between an outer periphery of the flanges and the sheave wheel. Preferably, the depth is at least 5 times greater than the width, for example at least 10 times greater than the width, for example about 15 times greater than the width. Such an arrangement ensures significant overlap between a line used with the sheave assembly and the pair of flanges defining the guide channel, which reduces the risk of the line jumping out of the guide channel.

In examples, at least one of the pair of flanges comprises an attachment feature located radially outward of the sheave wheel. In further examples, at least one of the pair of flanges comprises a plurality of attachment features located radially outward of the sheave wheel and distributed about the circumference of the housing. For example, the or each attachment feature may comprise a mounting hole, and in examples the or each attachment features may comprise a mounting hole extending through each of the pair of flanges.

In examples, the housing comprises a first housing plate comprising a first of the pair of flanges, and a second housing plate comprising a second of the pair of flanges. In examples, a recess is defined between the first and second housing plates, and the sheave wheel may be rotatably mounted in the recess. In examples, the first and second housing plates may be attached to each other at a location radially inward of the sheave wheel. Such an arrangement of the housing plates can provide for a simple and lightweight assembly. In addition, locating the sheave wheel in the recess between the first and second housing plates means that rotating parts of the sheave assembly are closed to the outside except through the guide channel, reducing the risk of any inadvertent contact between a user and the moving parts of the sheave assembly.

In examples, the sheave wheel may comprise a groove extending about a circumferential surface of the sheave wheel. In examples, the groove has a depth and a width, and the depth of the groove may be at least 2 times the width of the groove, for example the depth of the groove may be at least 4 times the width of the groove. In examples, the guide channel has a width that is substantially the same as a width of the groove.

Accordingly, there is significant side overlap between a line used with the sheave assembly and the groove in the sheave wheel, which reduces the risk of the line jumping out of the groove in the sheave wheel. When combined with the guide channel described above, there is a greatly reduced risk of the line leaving the groove and guide channel together and so the sheave assembly does not need any further guides or rollers to retain the line in place.

According to a further aspect of the present invention, there is also provided a sheave assembly comprising:
a housing with an attachment feature for attaching the sheave assembly to an external mounting point, and
a sheave wheel mounted to the housing for rotation relative to the housing;
wherein the sheave wheel comprises a bearing surface on which a line can be borne during use,
wherein the housing comprises a support surface on which the sheave wheel is rotatably mounted; and
wherein a ratio of a diameter of the support surface of the housing to a diameter of the bearing surface of the sheave wheel is at least 0.75.

Accordingly, during use the load is transferred from the line onto the sheave wheel via the bearing surface, and then onto the housing via the support surface. By reducing the distance from the bearing surface to the support surface the dimension of the sheave wheel in the load-bearing direction is reduced thereby reducing distortion, which can otherwise lead to the line being misaligned with the sheave wheel. Accordingly, a sheave wheel assembly of these dimensions improves reliability and operational life of the sheave assembly.

In some examples, a ratio of the distance between the support surface and the attachment feature to a peripheral diameter of the housing is less than about 0.50, or preferably less than about 0.33. During use load is transferred from the support surface to the attachment feature through the housing. By reducing this distance the distortion in the housing is also reduced.

In addition, by shortening the load path within the sheave assembly (by having the sheave wheel, support surface, and attachment feature close to each other), the weight of the sheave assembly can be reduced.

In some examples, the sheave assembly described above may further comprise a bearing. The sheave wheel may be mounted to the housing via the bearing. In examples, the bearing is a rolling bearing, for example a ball bearing or roller bearing (e.g., cylindrical or tapered or needle roller bearing). As the ratio of the diameter of the support surface of the housing to a diameter of the bearing surface of the sheave wheel is at least 0.75, the circumference of the bearing is relatively large. This spreads the load around a larger portion of the circumference of the bearing, and also means that each ball bearing, roller bearing, etc., is subjected to a reduced load cycle during use (lower loads and reduced frequency). Accordingly, the operational life of the bearing is improved when the ratio of the diameter of the support surface of the housing to a diameter of the bearing surface of the sheave wheel is at least 0.75.

In other examples, the bearing may be a bushing or plain bearing. The bushing may be self-lubricating or lubricated.

In examples, the sheave assembly may comprise a central opening extending through the housing and within an inner circumference of the sheave wheel. Such a central opening reduces the weight of the sheave assembly and may provide a convenient location for handling or lifting the sheave assembly by a chain, bracket or sling that can be looped or located through or on the side of the opening.

In examples, the sheave assembly may comprise one or more fixing points about an inner circumference of the housing, in particular about the central opening. Such fixing points may comprise holes for fasteners. In examples, the sheave assembly further comprises a side bracket attached to the one or more fixing points and adapted to mount the sheave assembly to a further structure, for example another part of the assembly. Such a side bracket is advantageous as the line can be freely placed into and removed from the sheave assembly.

In examples, the sheave assembly may comprise first and second sheave wheels. A spacer can be positioned between the first and second sheave wheels, within the housing. The spacer may provide a bearing seat for bearings of the first and second sheave wheels. A sheave assembly with first and second sheave wheels may advantageously carry two lines side-by-side.

In examples, the sheave assembly is a wireline sheave assembly or a slickline sheave assembly. Such a wireline or slickline sheave assembly is useable in a wireline/slickline rig up. A wireline/slickline rig up is mountable to a hydrocarbon well for routing a wireline/slickline into the well.

According to a further aspect of the present invention there is also provided a wireline/slickline rig up comprising the wireline sheave assembly and/or the slickline sheave assembly described above.

In examples, the wireline/slickline rig up comprises a first sheave assembly mountable as an upper pulley via an upper bracket, and a second sheave assembly mountable as a lower pulley via a lower bracket.

In examples, the upper and/or lower bracket can be attached to the sheave assembly via the attachment feature(s) on the flanges, and/or the upper and/or lower bracket can be attached to the sheave assembly via the side bracket mounted to the inner fixing points.

In examples, the wireline/slickline rig up may further comprise a stuffing box, and wherein the upper bracket may attach to the mounting feature of the first sheave assembly and to the stuffing box. Accordingly, the first sheave assembly is attachable to the stuffing box and positioned as the upper pulley in the wireline/slickline rig up.

In examples, the lower bracket may attach to the mounting feature of the second sheave assembly and to an anchor point. In examples, the anchor point may be on another part of the wireline rig up (e.g., on a lubricator), or on the hydrocarbon well (e.g., on the wireline valve/manifold). Accordingly, the second sheave assembly is attachable as the lower pulley in the wireline/slickline rig up.

The wireline/slickline rig up may comprise a drum of wireline/slickline that is routed into the hydrocarbon well via the upper and lower pulleys and the stuffing box. The wireline/slickline rig up may further comprise a load measurement assembly arranged to measure a tension in the wireline/slickline and the depth of the wireline/slickline run in and out of the well during use.

According to a further aspect of the present invention, there is also provided a wireline/slickline load measurement assembly comprising a first sheave assembly as described above, a second sheave assembly as described above, and a sensor attachment comprising a load sensor. The sensor attachment may be connected to attachment points of the first and second sheave assemblies such that during use a wireline/slickline can be wrapped around both of the first and second sheave wheels and the load sensor is operable to detect a tension in the wireline/slickline.

In examples, the first or second sheave assembly may comprise first and second sheave wheels, spaced apart by a spacer positioned between the first and second sheave wheels within the housing. In such examples, the wireline/slickline is routed around three sheave wheels and avoids any overlap with itself.

In examples, the wireline/slickline load measurement assembly may further comprise a pivot connector having a pivot. The pivot connector is attached to further attachment points of the first sheave assembly and the second sheave assembly, such that during use the first and second sheave assemblies are pivotable about the pivot. As the first and second sheave assemblies pivot the load sensor is operable to detect the tension in the wireline/slickline.

In various other examples, the sheave assembly described above may alternatively be used in other applications. For example, the sheave assembly may be used as a pulley block for sailing boats, or the sheave assembly may be used in lifting or hoisting equipment in industrial applications (particularly heavy industries such as mining) or in construction, such as on cranes. The size of the sheave assembly can be varied to any size according to the application. For example, in sailing the sheave wheel may have a relatively small diameter, between about 20 millimetres and about 100 millimetres, while for use on a crane the sheave wheel may have a diameter of between about 50 millimetres and about 300 millimetres.

### BRIEF DESCRIPTION OF THE DRAWINGS

As explained above, FIGS. 1A and 1B illustrate the prior art. In particular, FIG. 1A shows a wireline/slickline rig up mounted to a hydrocarbon well, and FIG. 1B shows a hay pulley typically used in the wireline/slickline rig of FIG. 1A.

Embodiments of the invention are further described hereinafter with reference to the accompanying drawings, in which;

FIG. 2 shows a sheave assembly according to an embodiment of the invention;

FIG. 3 shows a cross-section of the sheave assembly of FIG. 2;

FIG. 4 shows an exploded assembly view of the sheave assembly of FIGS. 2 and 3;

FIG. 5 shows a partial cross-section of the sheave assembly of FIGS. 2 to 4 with a wireline route illustrated;

FIG. 6 shows a magnified cross-section of the sheave assembly of FIGS. 2 to 4;

FIG. 7 shows a wireline/slickline rig comprises two of the sheave assemblies of FIGS. 2 to 6;

FIG. 8 shows a load measurement unit according an embodiment of the invention;

FIG. 9 shows the sheave assembly of FIGS. 2 to 6 with a wire wiper attachment;

FIG. 10 shows the sheave assembly of FIGS. 2 to 6 with a stand attachment;

FIG. 11 shows the sheave assembly of FIGS. 2 to 6 with a soft sling attachment for hoisting the sheave assembly during;

FIGS. 12A and 12B show a side adapter mounting plate for the sheave assembly of FIGS. 2 to 6;

FIG. 13A shows cross-sectional view of a spacer adaptor plate; and

FIG. 13B shows a cross-sectional view of sheave assembly with two sheave wheels and the spacer adapter plate of FIG. 13A.

### DETAILED DESCRIPTION

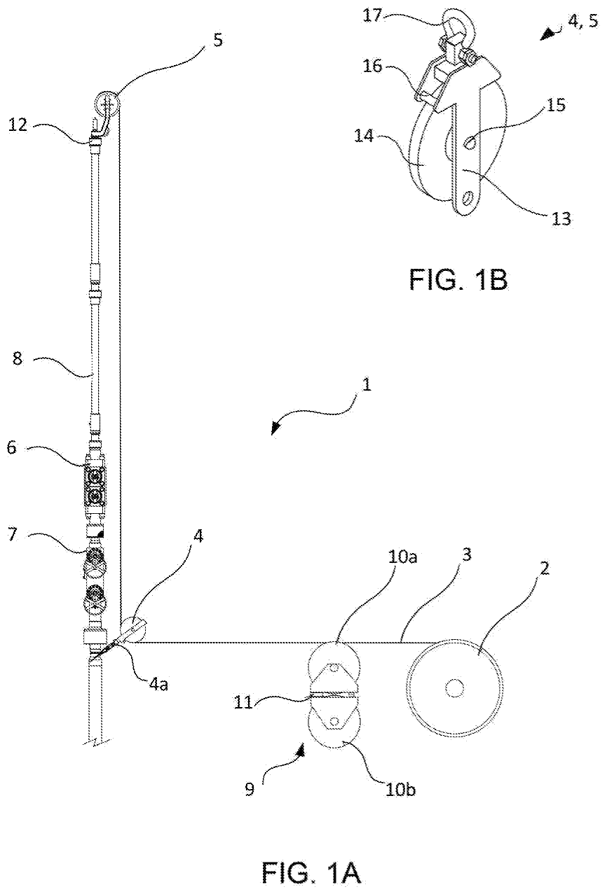

As shown in FIGS. 2 to 4, the sheave assembly 20 comprises a housing 21 with an attachment feature 22 for attaching the sheave assembly 20 to an external mounting point. The sheave assembly 20 also has a sheave wheel 23 mounted to the housing 21 for rotation relative to the housing 21. The housing 21 comprises a pair of flanges 25a, 25b extending radially past a periphery of the sheave wheel 23 so as to define a guide channel 26 aligned with the sheave wheel 23. The pair of flanges 25a, 25b extend about at least a substantial proportion of the circumference of the sheave wheel 23.

In the illustrated examples, the housing 21 is formed of a first housing plate 27a and a second housing plate 27b that are attached to each other. A bearing 24 is provided to rotatably mount the sheave wheel 23 to the housing 21. The bearing 24 and sheave wheel 23 are retained between the first and second housing plates 27a, 27b.

As illustrated, each of the first and second housing plates 27a, 27b has a recess 28a, 28b to receive the bearing 24 and sheave wheel 23. The bearing 24 is fixed within the recesses 28a, 28b and the sheave wheel 23 can rotate on the bearing 24 within the recesses 28a, 28b. In some examples, the bearing 24 and the inner circumferential surface of the recesses 28a, 28b have a transition or interference fit for fixing the bearing in the recesses 28a, 28b. In other examples, and depending what kind of bearing is used, the bearing may be adhered or fastened in the recesses 28a, 28b.

In this example, the first and second housing plates 27a, 27b are identical. In other examples, the first housing plate 27a may be provided with a recess 28a to house the bearing 24 and sheave wheel 23 and the second housing plate 27b may be flat.

The first and second housing plates 27a, 27b are attached to each other via screws 29 through corresponding assembly portions 30a, 30b of the first and second housing plates 27a, 27b. One of the first and second housing plates 27a, 27b may have a threaded hole for the screws 29, or the screws 29 may be provided with nuts to clamp the first and second housing plates 27a, 27b together. The assembly portions 30a, 30b are disposed radially inward of the recesses 28a, 28b, so that the screws 29 fasten the first and second housing plates 27a, 27b to each other radially inward of the bearing 24 and sheave wheel 23.

As mentioned above, each of the first and second housing plates 27a, 27b has a flange 25a, 25b that extends radially beyond the sheave wheel 23. The flanges 25a, 25b of the first and second housing plates 27a, 27b are spaced apart, defining a guide channel 26 therebetween. The guide channel 26 is aligned with the sheave wheel 23 and acts to guide the wireline/slickline onto the sheave wheel 23 and prevent the wireline/slickline from coming out of engagement with the sheave wheel 23, as described in further detail hereinafter.

In examples, the depth of the guide channel 26 may be at least 5 times greater than the width of the guide channel 26, for example at least 10 or 15 times greater. Accordingly, the guide channel 26 is deep and narrow and acts to hold the wireline/slickline in alignment with the sheave wheel 23.

In the illustrated example the flanges 25a, 25b extend about the entire circumference of the sheave wheel 20. In other examples, the flanges 25a, 25b may extend about a significant portion of the circumference of the sheave wheel 20 but not the entire circumference, for example more than 50%, or more than 75% or more than 80% of the circumference of the sheave wheel 20.

As illustrated, each flange 25a, 25b comprises a plurality of attachment features, in this example mounting holes 22. The mounting holes 22 in the flange 25a of the first housing plate 27a are aligned with the mounting holes 22 in the flange 25b of the second housing plate 27a so that a bolt or similar can pass through both mounting holes 22.

As described in more detail hereinafter, the mounting holes 22 can be used to attach the sheave assembly 20 to the wireline/slickline rig, for example via a bracket. Additionally or alternatively, the mounting holes 22 may be used to attach one or more attachments to the sheave assembly. Additionally or alternatively, the mounting holes 22 may be used to lift the sheave assembly 20 during installation and deinstallation, or when otherwise moving or working on the sheave assembly 20.

A bracket or other attachment can be attached to one or more of the two flanges 25a, 25b using one or more of the mounting holes 22. If the attachment might cause the flanges 25a, 25b to be deflected towards each other, for example due to a clamping effect, then a tubular insert can be provided between the two flanges 25a, 25b and aligned with the mounting holes 22 to prevent such deflection and maintain the guide channel 26.

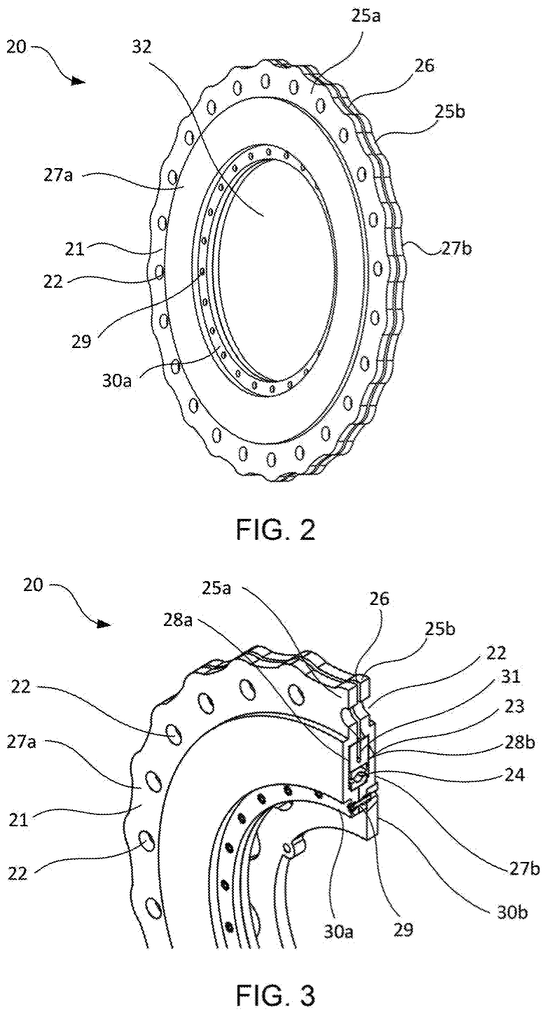

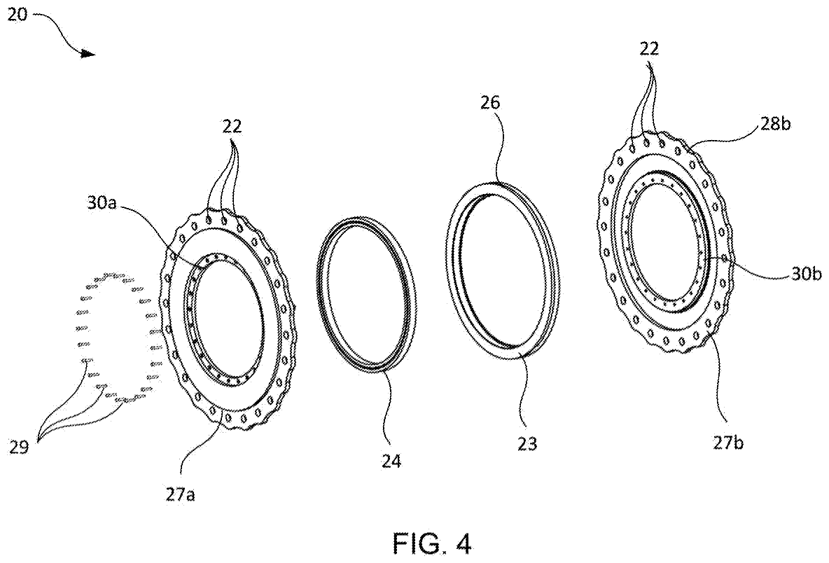

As shown best in FIGS. 3 and 4, the sheave wheel 23 has a groove 31 directed radially outwards. The groove 31 is aligned with the guide channel 26 formed between the flanges 25a, 25b. The groove 31 may have a width corresponding to the width of the guide channel 26, or a width greater than the width of the guide channel 26. The groove 31 is configured to receive the wireline/slickline. In examples, the depth of the groove 31 may be at least two times the width of the groove 31, or even 4 time the width of the groove 31. Providing a deep and narrow groove 31 can help to maintain alignment of the wireline/slickline and the sheave wheel 23.

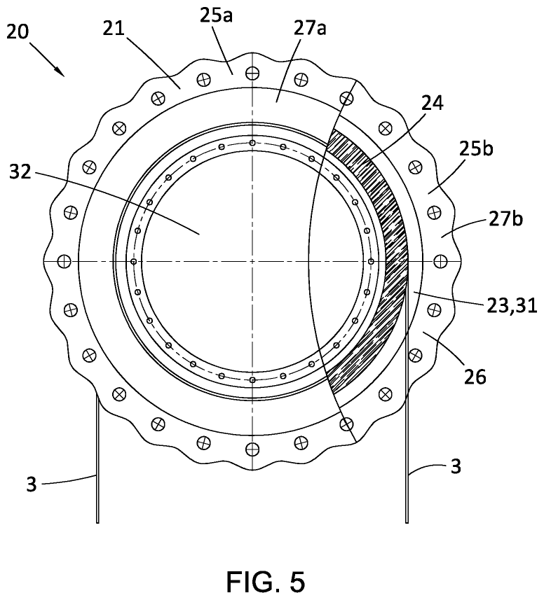

FIG. 5 shows a partial cross-section of the sheave assembly 20 with the wireline/slickline 3. A portion of the first housing plate 27a is cut away, exposing a portion of the sheave wheel 23, bearing 24, and second housing plate 27b. As shown, the wireline/slickline 3 passes through the guide channel 26 defined between the flanges 25a, 25b and into the groove 31 formed in the sheave wheel 23.

The flanges 25a, 25b and the guide channel 26 act to retain the wireline/slickline on the sheave wheel 23 during use. In particular, as the guide channel 26 extends away from the sheave wheel 23 in every direction, there is significant overlap between the flanges 25a, 15b and the wireline/slickline that prevents the wireline/slickline from moving out of alignment with the sheave wheel 23. In addition, the absence of rollers or guides near the entrance of the guide channel 26 means there is no pinch point which might cause the wireline/slickline to jump out of the guide channel 26. Accordingly, the flanges 25a, 25b and the guide channel 26 provide for more reliable operation of the sheave assembly 20.

In addition, the groove 31 in the sheave wheel 23 provides additional overlap between the sheave assembly 20 and the wireline/slickline 3 to further reduce the likelihood of the wireline/slickline disengaging the sheave wheel 23.

In the example illustrated in FIG. 5 the wireline/slickline 3 has a 180 degree wrap around the sheave assembly 20. However, regardless of the angle of wrap of the wireline/slickline 3 about the sheave assembly 20, in particular the sheave wheel 23, the flanges 25a, 25b, guide channel 26, and groove 31 in the sheave wheel 23 will act to retain alignment of the wireline/slickline 3 and the sheave wheel 23.

In addition, as will be apparent from FIGS. 2 to 5, all moving parts of the sheave assembly 20 are enclosed within the housing 21, and so no moving parts can be accessed by an operator. This improves the safety of the sheave assembly 20.

In the examples illustrated in FIGS. 2 to 4 the bearing 24 a rolling bearing, in particular a ball bearing. However, in other examples the bearing 24 may be a roller bearing (e.g., cylindrical or tapered or needle roller bearing). In other examples, the bearing 24 may be a bushing or plain bearing, for example a metal, polymer, or metal-polymer bushing. The bushing may be self-lubricating. In some examples, the sheave assembly 20 may not include a bearing 24, and the sheave wheel 23 may be mounted directly on the housing 21 such that the sheave wheel 23 can rotate relative to the housing 21. In such examples an inner portion of the sheave wheel 23 may comprise a bushing portion. The busing portion may be metal or polymer, and may be self-lubricating.

In a preferred example, the housing 21, in particular the housing plates 27a, 27b are made of stainless steel, the sheave wheel 23 is made of stainless steel, and the bearing 24 is a ball or roller bearing made of stainless steel. During use the wireline/slickline will bring contaminants up from the well and such contaminants can be corrosive. In addition, the general environment of a wireline/slickline rig is corrosive, so stainless steel is preferred to resist corrosion.

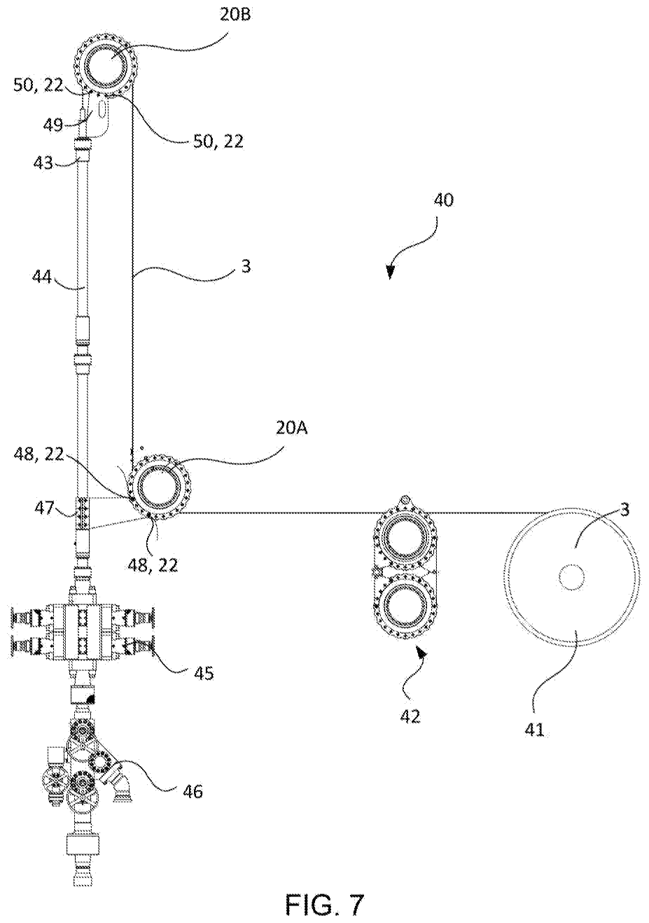

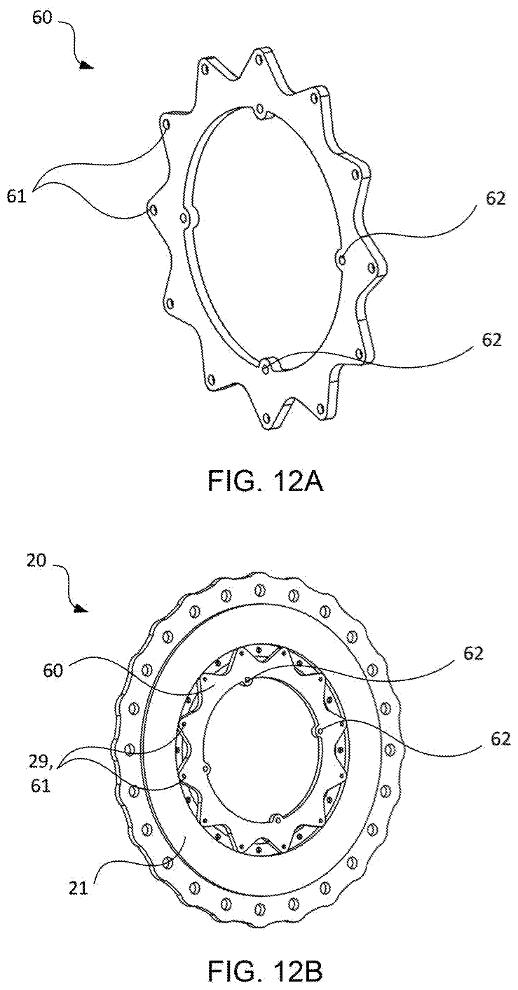

As illustrated in FIG. 5, the sheave assembly 20, in particular the housing 21, has a central opening 32 in the form of a through-hole. The central opening 32 is radially inward of the sheave wheel 23, bearing 24 and assembly portions 30a, 30b. The central opening 32 reduces the weight of the sheave assembly 20 and, as illustrated in FIG. 11, allows a sling 33 or rope or similar to be attached through the central opening 32 for lifting the sheave assembly 20, for example during assembly or disassembly. As shown in FIG. 11, the sling 33 can be attached to the sheave assembly 20 when the wireline/slickline 3 is in place on the sheave wheel 23. This may be advantageous, for example, for assembly of sheave assembly 20 onto a lubricator as the upper pulley as described with reference to FIG. 7 below.

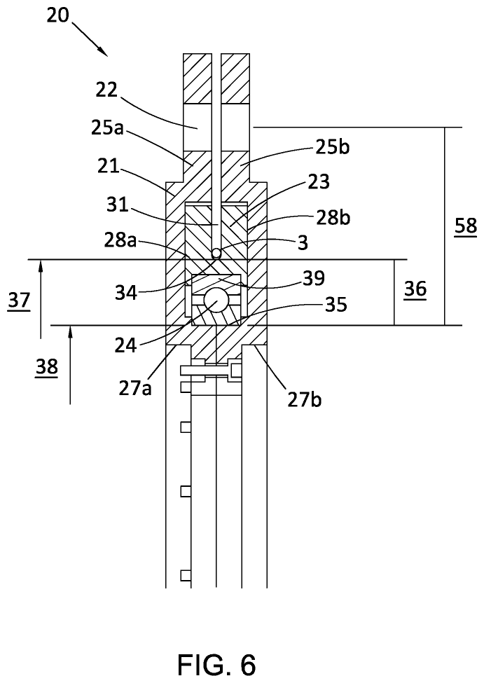

As shown in FIG. 6, the sheave wheel 23, and the bearing 24 if provided, form a rotary assembly 39 that is supported on the housing 21 and rotates relative to the housing 21. In this example the sheave wheel 23 has a groove 31 to receive the wireline/slickline 3, and a bearing surface 34 of the sheave wheel 23 bears the wireline/slickline-that is, the wireline/slickline 3 is in contact with the bearing surface 34 of the sheave wheel 23. It will be appreciated that the sheave wheel 23 may not have a groove 31, and the wireline/slickline 3 may be borne on an external surface of the sheave wheel 23. As also illustrated, the housing 21, in particular the recesses 28a, 28b in the first and second housing plates 27a, 27b, define a supporting surface 35 that supports the rotary assembly 39. In this example, the supporting surface 35 supports the bearing 24, but in some examples without a bearing 24 the sheave wheel 23 may be borne directly on the supporting surface 35. During operation, tension in the wireline/slickline 3 imparts a load onto the sheave wheel 23, and that load is transferred to the housing 21 (via the bearing 24 if provided), and from the housing 21 to an external assembly (e.g., lubricator) via the mounting hole(s) 22.

The sheave assembly 20 described herein advantageously reduces the length of the load path from the bearing surface 34 of the sheave wheel 23 to the supporting surface 35 of the housing 21. Reducing this distance reduces distortion in the components of the rotary assembly 39, particularly in the sheave wheel 23, thereby helping the wireline/slickline 3 to remain in the correct position and increasing the operational lifetime of the sheave assembly.

In particular examples, a ratio of the diameter 38 of the supporting surface 35 of the housing 21 to the diameter 37 of the bearing surface 34 of the sheave wheel 23 is at least about 0.80, for example at least about 0.85. The ratio of the diameter 38 of the supporting surface 35 of the housing 21 to the diameter 37 of the bearing surface 34 of the sheave wheel 23 may be between about 0.80 and about 0.98, for example between about 0.87 and about 0.96.

Table 1 below illustrates several examples of the diameters 37, 38 for several common sheave wheel 23 diameters as used in wireline/slickline applications. In these examples, the bearing 24 has a height of 25.5 millimetres and when assembled the radial distance from the outer surface of the bearing 24 to the bearing surface 34 on the sheave wheel 23 is about 7.5 millimetres. Accordingly, the distance 36 is 33 millimetres. It will be appreciated that this dimension and the values in Table 1 will change if a different bearing 24 is used in the rotary assembly 39.

TABLE 1
Example Dimensions of Sheave Assembly and Wireline/Slickline

| | | Ratio of housing | | |
|---|---|---|---|---|
| Sheave Wheel | Housing | support surface | | |
| Bearing | support | 35 diameter to | Maximum | Maximum |
| Surface 34 | surface 35 | sheave Wheel | wireline | slickline |
| Diameter | diameter | Bearing Surface | diameter | diameter |
| (mm) | (mm) | 34 Diameter | (mm) | (mm) |
| 254 (10″) | 221 | 0.87 | 4.2 | 2.1 |
| 280 (11″) | 247 | 0.88 | 4.7 | 2.4 |
| 381 (15″) | 348 | 0.91 | 6.4 | 3.2 |
| 406 (16″) | 373 | 0.92 | 6.8 | 3.4 |
| 508 (20″) | 475 | 0.94 | 8.5 | 4.3 |
| 660 (26″) | 627 | 0.95 | 11.0 | 5.5 |
| 762 (30″) | 729 | 0.96 | 12.7 | 6.4 |

A rule of thumb used widely in the wireline/slickline industry is that the minimum diameter of the sheave wheel 23 for a wireline should be 60 times greater than the diameter of the wireline Similarly, the minimum diameter of the sheave wheel 23 for a slickline should be 120 times greater than the diameter of the wireline. Accordingly, as shown in the above table, certain sheave assemblies 20 can be used with wirelines or slicklines having the indicated minimum diameters. Common wireline diameters include ⅜ inch (9.5 mm), 7/16 inch (11.5 mm), and ½ inch (13 mm). Common slickline diameters include 0.072 inches (1.8 mm), 0.082 inches (2.1 mm), 0.092 inches (2.3 mm), 0.108 inches (2.7 mm), 0.125 inches (3.2 mm), 0.140 inches (3.6 mm), and 0.160 inches (4.1 mm).

As also illustrated in FIG. 7, the sheave assembly 20 advantageously reduces the distance from the rotary assembly 39 to the mounting holes 22 for attaching the sheave assembly 20 to an external point. In particular, as shown in FIG. 7, the distance 58 between the support surface 35 of the housing 21 and the mounting holes 22 is significantly less than the distance between the attachment feature 17 and the shaft 15 of the pulley 4, 5 illustrated in FIG. 1B. In examples, a ratio of the distance 58 to a peripheral diameter of the housing (i.e., the outer diameter of the flanges 25a, 25b) is less than about 0.50 (a half), or less than about 0.33 (a third). Reducing this distance provides for a lighter weight housing 21, as less material is needed, and also helps to reduce distortion of the housing 21 when loads are applied. Also, a lighter housing 21 makes the sheave assembly 20 safer to manually handle.

According to one example of the invention the sheave assembly 20 has a housing 21 with an attachment feature 22 for attaching the sheave assembly 20 to an external mounting point. The sheave assembly 20 also has a sheave wheel 23 mounted to the housing 21 for rotation relative to the housing 21. The sheave wheel 23 comprises a bearing surface 34 on which a line 3 (e.g., a wireline/slickline) can be borne during use. The housing 21 comprises a support surface 35 on which the sheave wheel 23 is rotatably mounted. In this example, a ratio of a diameter 38 of the support surface 35 of the housing 21 to a diameter 37 of the bearing surface 34 of the sheave wheel 23 is at least 0.75, for example at least about 0.80, particularly at least about 0.85. The ratio of the diameter 38 of the supporting surface 35 of the housing 21 to the diameter 37 of the bearing surface 34 of the sheave wheel 23 may be between about 0.80 and about 0.98, for example between about 0.87 and about 0.96.

This example sheave assembly 20 optionally includes the other features of the sheave assembly 20 as described with reference to the FIGS. 2 to 5, in particular the flanges 25a, 25b, the guide channel 26, a groove 31 in the sheave wheel 23, and the various options for the mounting holes 22 and assembly portions 30a, 30b.

As shown in FIG. 7, a wireline/slickline rig up assembly 40 can comprise a first sheave assembly 20A acting as the lower pulley, and a second sheave assembly 20B acting as the upper pulley. Each of the first and second sheave assemblies 20A, 20B are as described above with reference to FIGS. 2 to 6. The wireline/slickline 3 is provided on a drum 41 and routed into the stuffing box 43 on the lubricator 44 via the first and second sheave assemblies 20A, 20B. The lubricator 44 is mounted on a wireline valve or manifold 45 of the well 46 so that the wireline/slickline 3 can be lowered into the well 7 and retracted by operation of the drum 41.

As illustrated in FIG. 7, the first sheave assembly 20A is mounted to the lubricator 44 by mounting bracket 47. The first sheave assembly 20A is attached to the mounting bracket 47 by two or more, in this example three, bolts 48 passed through mounting holes 22 in the first sheave assembly 20A. Accordingly, the position of the first sheave assembly 20A is fixed on the lubricator 44.

In the mounting position shown in FIG. 7 the bolts 48 also act to retain the wireline/slickline 3 in the guide channel of the first sheave assembly 20A because the bolts 48 block the guide channel.

In an alternative example, the bracket 47 may be attached to the wireline valve or manifold 45 or other equipment present at the well site. The bracket 47 may be universal or may be configured to be connected to different types of equipment, providing versatility in the mounting position of the first sheave assembly 20A.

As illustrated in FIG. 7, the second sheave assembly 20B is mounted to the stuffing box 43 by mounting bracket 49. The second sheave assembly 20B is attached to the mounting bracket 49 by two or more bolts 50 passed through mounting holes 22 in the second sheave assembly 20B. Accordingly, the position of the second sheave assembly 20B is fixed on the lubricator 44, in particular on the stuffing box 43. The mounting bracket 49 may be a universal mounting bracket for attachment to various stuffing boxes 43.

Accordingly, the same sheave assembly 20 as described with reference to FIGS. 2 to 6 can be used as the lower and upper pulleys in the wireline/slickline rig up 40 shown in FIG. 7, with different mounting brackets 47, 49 to attach the sheave assemblies 20A, 20B in the different locations. This reduces the number of products and spare parts and simplifies manufacturing.

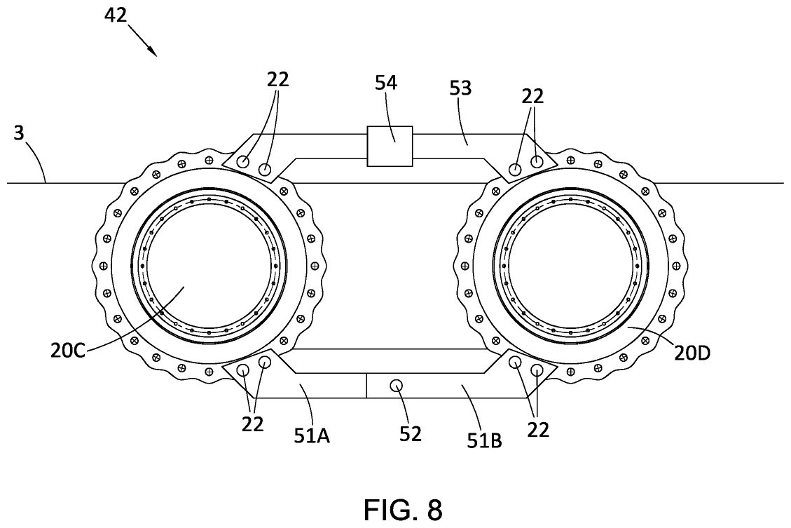

As also shown in FIG. 7, a load measurement unit 42 is provided between the drum 41 and the first sheave assembly 20A (lower pulley). As shown in FIG. 8, the load measurement unit 42 comprises a first sheave assembly 20C and a second sheave assembly 20D, each as described with reference to FIGS. 2 to 6. The first and second sheave assemblies 20C, 20D are connected to each other by a pivot arm 51 formed of: a first pivot arm portion 51A attached to the first sheave assembly 20C at mounting holes 22; a second pivot arm portion 51B attached to the second sheave assembly 20D at mounting holes 22; and a pivot 52 attaching the first and second pivot arm portions 51A, 51B to each other. Accordingly, the first and second sheave assemblies 20C, 20D can pivot relative to each other about the pivot 52. The first and second sheave assemblies 20C, 20D are also connected to each other by a sensor arm 53 disposed opposite to the pivot arm 51. The sensor arm 53 is attached to both the first and second sheave assemblies 20C, 20D via mounting holes 22, and includes a sensor, e.g., a load cell, arranged to measure the force with which the first and second sheave assemblies 20C, 20D are being pushed towards each other.

In use, as illustrated in FIGS. 7 and 8, the wireline/slickline 3 from the drum 41 is wrapped about both the first and second sheave assemblies 20C, 20D and then fed to lower pulley, so that the tension in the wireline/slickline 3 acts to urge the two sheave assemblies 20C, 20D together and the tension in the wireline/slickline 3 can be determined from the force detected by the load cell 54. The first and second sheave assemblies 200, 20D are angled slightly with respect to each other so that the wireline/slickline 3 passes both around and alongside each of the first and second sheave assemblies 20C, 20D. In particular, the wireline/slickline 3 passes from the drum 41, alongside the second sheave assembly 20D, around the first sheave assembly 20C, around the second sheave assembly 20D, then alongside the first sheave assembly 20C towards the well as shown in FIG. 7. Rollers or guides (not shown) may be provided on the pivot arm 51 and/or sensor arm 53 and/or one or both of the sheave assemblies 20C, 20D to guide the wireline/slickline 3 alongside the sheave assemblies 20C, 20D.

Accordingly, this example further demonstrates the versatility of the sheave assembly 20 of FIGS. 2 to 6, which with the pivot arm 51 and sensor arm 53 described above can be combined to provide a load measurement unit 42.

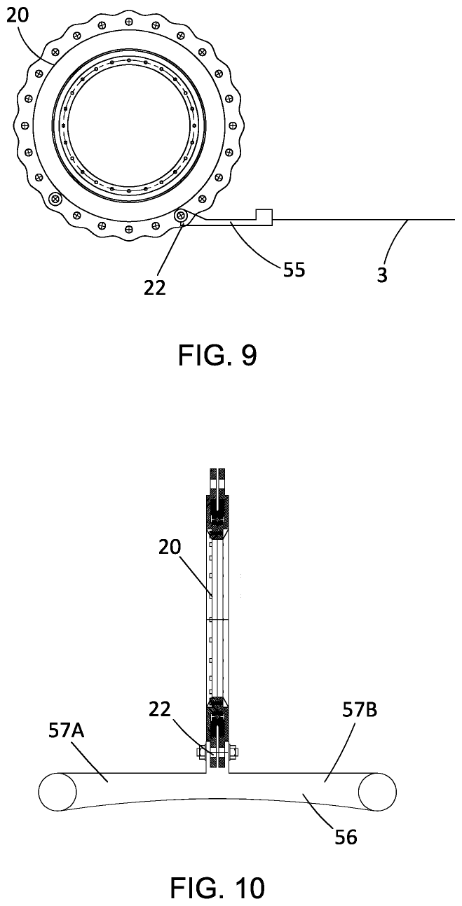

As shown in FIG. 9, a wire wiper 55 may be attached to the sheave assembly 20, particularly if used as the lower pulley as described with reference to FIG. 7. The wire wiper 55 includes a passage through which the wireline/slickline 3 passes, and a wiper arranged to remove material that may have accumulated on the wireline/slickline 3. The wire wiper 55 is attached to the sheave assembly 20 by a mounting hole 22.

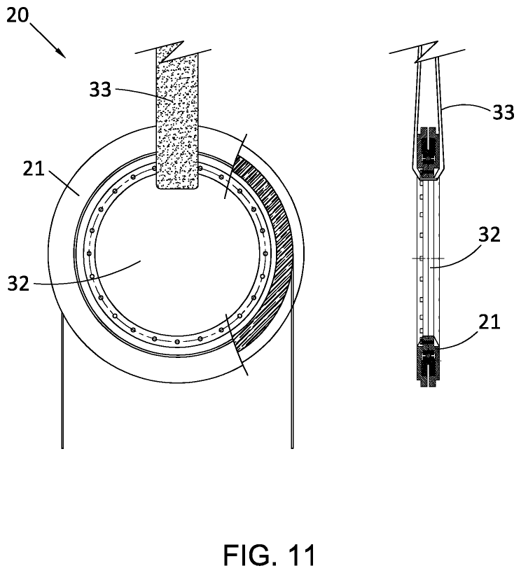

As shown in FIG. 10, a stand 56 may be attached to the sheave assembly 20 at one or more mounting holes 22. The stand 56 has two divergent legs 57A, 57B so that the sheave assembly 20 can be held in an upright position on the ground. The stand 56 may be useful during assembly and disassembly of the wireline/slickline rig up 40 shown in FIG. 7, as the wireline/slickline can be positioned in the sheave assembly 20 as it is held by the stand 56, and then lifted/hoisted into position on the well.

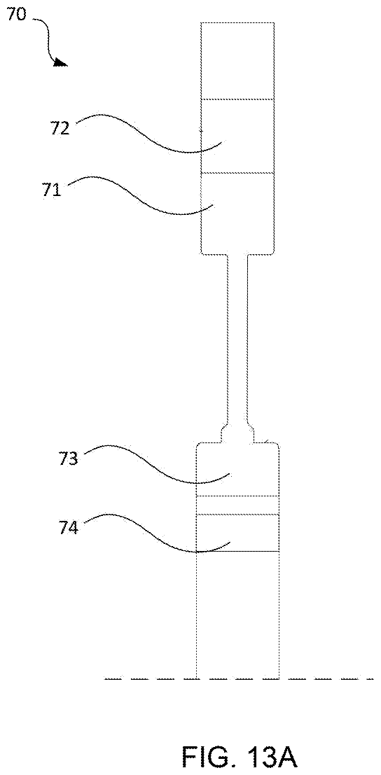

FIGS. 12A and 12B illustrate a side adapter mounting plate 60 for mounting the sheave assembly 20 at its centre, leaving the circumferential edge open. As shown in FIG. 12, the side adapter mounting plate 60 has at least one outer mounting hole 61 for connecting to the sheave assembly at one or more of the screws 29 that hold the housing 21 together as shown in FIG. 12B. The side adapter mounting plate 60 also includes inner holes 62 for attaching the side adapter mounting plate 60 and sheave assembly 20 to a further assembly, for example on the rig up 40 shown in FIG. 7. The central mounting provided by the side adapter mounting plate 60 ensures that the wireline/slickline can be inserted into and removed from the sheave assembly 20 without having to thread the wireline/slickline.

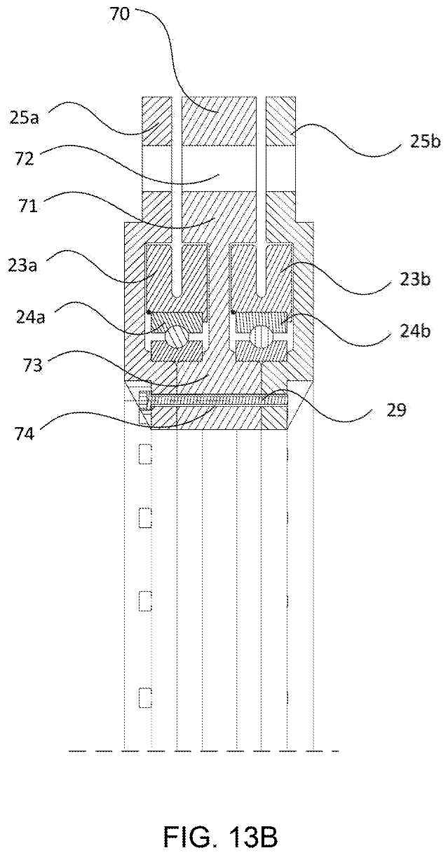

FIGS. 13A and 13B illustrate an example sheave assembly 20 with two sheave wheels 23a, 23b and a spacer adapter plate 70. The spacer adapter plate 70, shown in FIG. 13A, comprises a first spacer portion 71 adapted to sit between the first and second housing plates 25a, 25b. The first spacer portion 71 includes holes 72 that correspond to the mounting features 22 in the housing 21. The spacer adapter plate 70 also comprises a second spacer portion 73 adapted to sit between the first and second housing plates 25a, 25b in the region of the bearing 24 and provide a seat for the bearing 24. The second spacer portion 73 also includes holes 74 that correspond to the screws 29 for attaching the first and second housing plates 25a, 25b to each other. The screws 29 pass through the second spacer portion 73 (in particular the holes 74) to secure the first and second housing plates 25a, 25b to each other. Accordingly, the spacer adapter plate 71 is sandwiched between the first and second housing plates 25a, 25b and provides for a sheave assembly 20 having two sheave wheels 23a, 23b arranged alongside each other, as shown in FIG. 13B.

It will be appreciated that further spacer adapter plates 70 may be provided, allowing for three or more sheave wheels 23 to be provided alongside each other.

The various examples of the sheave assembly 20 described herein therefore provide several advantages over the hay pulleys 4, 5 as described with reference to FIGS. 1A and 1B. For example, the sheave assembly 20 is lightweight and can be more easily handled during assembly and disassembly, the sheave assembly 20 experiences less distortion of the rotary components and supporting structure during use due to the relatively short load path, and the sheave assembly 20 can be combined with various attachments to provide many different functions within a wireline/slickline rig up 40 as shown in FIG. 7.

The various examples of the sheave assembly 20 described with reference to FIGS. 2 to 13B may also be used in other applications. For example, the sheave assembly 20 may be used as a pulley block for sailing boats, or the sheave assembly 20 may be used in lifting or hoisting equipment in industrial applications (particularly heavy industries such as mining) or in construction, such as on cranes. The size of the sheave assembly 20 can be varied according to the application. For example, in sailing the sheave wheel 23 may be a relatively small diameter, between about 20 millimetres and about 100 millimetres, while for use on a crane the sheave wheel 23 may have a diameter of between about 50 millimetres and about 600 millimetres.

Throughout the description and claims of this specification, the words “comprise” and “contain” and variations of them mean “including but not limited to”, and they are not intended to (and do not) exclude other components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. A sheave assembly comprising:
a housing with an attachment feature for attaching the sheave assembly to an external mounting point, and
a sheave wheel mounted to the housing for rotation relative to the housing;
wherein the housing comprises a pair of flanges extending radially past a periphery of the sheave wheel so as to define a guide channel aligned with the sheave wheel, and wherein the pair of flanges extend substantially entirely about the circumference of the sheave wheel.

2. The sheave assembly of claim 1, wherein the guide channel comprises a width between the pair of flanges, and a depth between an outer periphery of the flanges and the sheave wheel, and wherein the depth is at least 5 times greater than the width, for example at least 10 times greater than the width, for example about 15 times greater than the width.

3. The sheave assembly of claim 1, wherein at least one of the pair of flanges comprises an attachment feature located radially outward of the sheave wheel.

4. The sheave assembly of claim 3, wherein the at least one of the pair of flanges comprises a plurality of attachment features located radially outward of the sheave wheel and distributed about the circumference of the housing.

5. The sheave assembly of claim 3, wherein at least one of the pair of flanges comprises one or more attachment features located radially inwards of the sheave wheel.

6. The sheave assembly of claim 3, wherein the or each attachment feature comprises a mounting hole.

7. The sheave assembly of claim 6, wherein the or each attachment features comprises a mounting hole extending through each of the pair of flanges.

8. The sheave assembly of claim 1, wherein the housing comprises:
a first housing plate comprising a first of the pair of flanges, and
a second housing plate comprising a second of the pair of flanges.

9. The sheave assembly of claim 8, wherein a recess is defined between the first and second housing plates, and wherein the sheave wheel is rotatably mounted in the recess.

10. The sheave assembly of claim 8, wherein the first and second housing plates are attached to each other at a location radially inward of the sheave wheel.

11. The sheave assembly of claim 1, wherein the sheave wheel comprises a groove extending about a circumferential surface of the sheave wheel.

12. The sheave assembly of claim 11, wherein the groove has a depth and a width, and wherein the depth of the groove is at least 2 times the width of the groove, preferably the depth of the groove is at least 4 times the width of the groove.

13. The sheave assembly of claim 11, wherein the guide channel has a width that is substantially the same as a width of the groove.

14. A sheave assembly comprising:
a housing with an attachment feature for attaching the sheave assembly to an external mounting point, and
a sheave wheel mounted to the housing for rotation relative to the housing;
wherein the sheave wheel comprises a bearing surface on which a line can be borne during use,
wherein the housing comprises a support surface on which the sheave wheel is rotatably mounted; and
wherein a ratio of a diameter of the support surface of the housing to a diameter of the bearing surface of the sheave wheel is at least 0.75.

15. The sheave assembly of claim 14, wherein a ratio of the distance between the support surface and the attachment feature to a peripheral diameter of the housing is less than about 0.50, or preferably less than about 0.33.

16. The sheave assembly of claim 1, further comprising a bearing, wherein the sheave wheel is mounted to the housing via the bearing.

17. The sheave assembly of claim 1, comprising a central opening extending through the housing and within an inner circumference of the sheave wheel.

18. The sheave assembly of claim 1, wherein the sheave assembly is a wireline sheave assembly or a slickline sheave assembly.

19. A wireline/slickline rig comprising the wireline sheave assembly and/or the slickline sheave assembly of claim 18.

20. The wireline/slickline rig of claim 19, comprising a first sheave assembly mountable as an upper pulley via an upper bracket, and a second sheave assembly mountable as a lower pulley via a lower bracket.

21. The wireline/slickline rig of claim 20, further comprising a stuffing box, and wherein the upper bracket attaches to the mounting feature of the first sheave assembly and to the stuffing box.

22. The wireline/slickline rig of claim 20, wherein the lower bracket attaches to the mounting feature of the second sheave assembly and to an anchor point, for example on the wireline rig or on a well.

23. A wireline/slickline load measurement assembly comprising a first sheave assembly according to claim 1, a second sheave assembly according to claim 1, and a sensor attachment comprising a load sensor, the sensor attachment being connected to attachment points of the first and second sheave assemblies such that during use a wireline/slickline can be wrapped around both of the first and second sheave wheels and the load sensor is operable to detect a tension in the wireline/slickline.

24. The wireline/slickline load measurement assembly of claim 23, further comprising a pivot connector having a pivot, the pivot connector being attached to further attachment points of the first sheave assembly and the second sheave assembly such that during use the first and second sheave assemblies are pivotable about the pivot and the load sensor is operable to detect the tension in the wireline/slickline.
